(19) United States
(12) Patent Application Publication
(10) Pub. No.: US 2024/0328576 A1
(43) Pub. Date: Oct. 3, 2024

(54) Wall Mount System for a Tablet

(71) Applicant: Displine GmbH, Weisbaden (DE)

(72) Inventors: Piotr STANCZYK, Wiesbaden (DE); Bartlomiej NEDZI, Radom (PL)

(21) Appl. No.: 18/622,948

(22) Filed: Mar. 31, 2024

(30) Foreign Application Priority Data
Mar. 31, 2023 (DE) 202023101654.5

(51) Int. Cl. F16M 13/02; F16M 11/04

(52) U.S. Cl. CPC F16M 13/02; F16M 11/041

(57) ABSTRACT

The present invention pertains to a wall mount system for a tablet, the wall mount system comprising: a frame member, the frame member having the following features: a receptacle to provide a retention for the tablet in the receptacle, a rear side which faces a wall in the assembled state, a front side, which is opposite the rear side, a first fastening means, the first fastening means being arranged at the rear side of the frame member, a screen cutout for a screen of the tablet; and a wall mount, the wall mount having the following features: a first counterpart fastener, the first counterpart fastener being configured for connection to the first fastening means of the frame member, holes for fixing the wall mount of the wall, at least one foam pad for retaining the tablet, and a central recess to allow the wall mount (9) to be positioned above a power supply unit.

The invention relates to a wall mount system for a tablet.

In the prior art, it is known that tablets can be attached to a wall in various ways. For example, there can be a wall mount in which the tablet is fastened via a snap or clip connection. The snap or clip connection can cover the edge of the tablet only partially with individual elements or completely, as is also known from tablet protective covers. Known wall mounts may further be pivotable. A wall mount for tablets is disclosed in US20170003712 A1, for example.

The present invention is based on the task of providing an improvement or an alternative to the prior art. In particular, the aim is to provide a modular wall mount system with an improved mount for the tablet.

In the context of this task, another task of the invention consists in providing a wall mount system that features a versatile frame member configured to accommodate various tablets.

According to a first aspect, the set task is solved by a wall mount system for a tablet according to claim 1.

The wall mount system according to the invention comprises a frame member, the frame member having the following features:
a receptacle to provide a mount for the tablet in the receptacle,
a rear side that faces a wall when mounted,
a front side, which is opposite to the back side,
a first fastening means, the first fastening means being arranged at the rear side of the frame member, and
a screen cutout for a screen of the tablet.

In addition, the wall mount system according to the invention comprises a wall mount having the following features:
a first counterpart fastener, the first counterpart fastener being configured for connection to the first fastening means of the frame member,
holes for mounting the wall mount of the wall,
at least one foam pad to hold the tablet,
a central recess to allow placement of the wall mount above a power supply.

Further advantageous embodiments of the invention are given in the dependent claims.

Conceptually, the following should be explained:

It is expressly pointed out that in the context of the present patent application indefinite articles and indefinite numerical indications such as “one . . . ”, “two . . . ” etc. are as a rule to be understood as indicating a minimum, i.e. “at least one . . . ”, “at least two . . . ” etc., unless it is clear from the context or the specific text of a particular passage that only “exactly one . . . ”, “exactly two . . . ” etc. are intended. Furthermore, all numerical data as well as data on process parameters and/or device parameters are to be understood in the technical sense, i.e. as having the usual tolerances. Also from the explicit restriction “at least” or the like it must not be concluded that with the simple use of “one”, i.e. without the indication of “at least” or the like, “exactly one” is intended.

According to the invention, a tablet can be, for example, an iPad, or an Android device. The mounted state is in particular the case when the frame member is connected to the wall mount and/or when the wall mount is attached to a wall. According to the invention, a fastening means can be part of a two-part fastening means, that is, for example, a recess for a corresponding snap-in or latching element, or a snap-in or latching element for a corresponding recess. Thus, in particular, the first and second counterpart fasteners of the wall mount form the respective complementary element for the respective first and second fastening means of the frame member. The attachment of the wall mount to the wall may be achieved by screws passing through the holes of the wall mount. According to the invention, a foam pad may be made of various materials, for example cellular plastic, polystyrene or rubber. The foam pads can be detachably attached to the wall mount, for example by a plug-in connection, or non-detachably, for example by an adhesive connection. At least two and preferably four holes can be provided in the wall mount.

Preferably, the frame member further comprises a second fastening means, the second fastening means being disposed at the rear of the frame member and the wall mount further comprising a second counterpart fastener, the second counterpart fastener being configured for connection to the second fastening means of the frame member. The second fastening means and the corresponding second counterpart fastening means serve as additional securing means for the connection between the frame member and the wall mount.

It may further be envisaged that the receptacle is formed as a protruding edge on the front side of the frame member with a side wall extending toward the rear side to lock insertion of the tablet into the receptacle with the protruding edge. In other words, the tablet is inserted into the frame member from the rear until it abuts against the protruding edge.

Further, the frame member may further comprise at least one silicone pad to provide improved retention of the tablet, wherein the at least one silicone pad is preferably arranged in the sidewall. In addition to improving the retention of the tablet, the at least one silicone pad also ensures that different types of tablets with different sizes can fit into the receptacle of the frame member. Thus, advantageously, different thicknesses of the silicone pads may be provided, which vary depending on the tablet size and are accordingly fixed in the frame member. The silicone pads may be made of other materials besides silicone, as long as the purpose of improved retention and adaptation to different tablet sizes is achieved.

In a further embodiment, the first fastening means is formed as a magnet and the first counterpart fastening means is formed of a metal material to releasably fasten the frame member to the wall mount with the magnet. Preferably, the metal material at least partially forms the wall mount, and further preferably the wall mount is made of the metal material. In other words, the wall mount may either be constructed in one piece from the metal material, or it may have a plurality of layers or sections formed from the metal material, in which latter case the position of the metal material in the assembled state corresponds to the position of the magnets.

It is conceivable that at least two, preferably four magnets are provided as the first fastening means on the rear side of the frame member. For optimized retention of the frame member on the wall mount, the magnets can be arranged on respective opposite sides of the frame member, for example at or near each of the four corners of the frame member. It is also conceivable that eight magnets are provided on the frame member. Furthermore, magnets can be replaced by other fastening means such as adhesive pads.

It may be advantageous if the second fastening means is formed as a recess on the rear side of the frame member, wherein the second counterpart fastening means on the wall mount is formed as a snap element for fastening the frame member to the wall mount in a preferably releasable manner. In other words, a corresponding snap system is present here, in which the second fastening means of the frame member cooperates with the second counterpart fastening means of the wall mount, in that the second counterpart fastening means is insertable as a snap element into the second fastening means, which forms a recess. A reverse version is also conceivable, in which the second fastening means is designed as a snap element and the second counterpart fastening means is designed as a recess.

In another example, at least two snap elements are provided as counterpart fasteners. Alternatively or additionally, the snap element(s) may be formed in one piece with the wall mount. In the case of at least two snap elements, one snap element can be formed on each of the opposite sides in order to improve the retention of the frame member on the wall mount.

In addition, a third fastening means can be provided, which is preferably formed as a hole in the frame member with a matching safety screw, in order to detachably fasten the frame member to the wall mount. The third fastening means can counteract the tablet falling out.

The frame member may be substantially rectangular and have inner rounded corners around the screen cutout.

The frame member may be substantially rectangular and have outer rounded corners.

It is advantageous if at least one inner rounded corner is composed of circular subregions with different radii and/or if at least one outer rounded corner is composed of circular subregions with different radii. The embodiment of the inner and/or outer corners with partial circular areas with different radii is generally advantageous from a manufacturing point of view and easier to realize, in particular with regard to rounded corners which take the course of a spline curve. In addition, manufacturing tolerances are less strict. It is also further advantageous to form all corners, in particular the inner corners, with circular sections having different radii.

The frame member may be substantially rectangular and have rounded corners. The length to width ratio of the frame member preferably corresponds to that of a conventional tablet, preferably with a protrusion provided to allow the first and second fastening means of the frame member to be disposed therein. The protrusion may be provided by at least one side wall or both side walls on one short side or on both short sides of the frame member.

Further, the frame member may have inner rounded corners around the screen cutout and outer rounded corners at the corners of the frame member. Alternatively or additionally, the embodiment of the inner rounded corners and the outer rounded corners may be such that at least one side wall of the frame member is thicker than the other side walls of the frame member. Accordingly, the protrusion described above exists at this at least one side wall. A larger protrusion advantageously provides more space for providing fastening means and the like.

In an advantageous embodiment, the frame member has a recess in the side wall for storage of different types of plugs and/or adapters. Since the frame member is designed for different types of tablets such as iPads and different Android devices, it may be advantageous to provide different types of plugs or adapters in the recess, such as for a USB-C and/or a Lightning connector. This allows quick switching from one type of tablet such as an iPad to another type of tablet such as an Android device.

It is conceivable that the wall mount has a cable passage that is preferably aligned with the recess in the mounted state of the wall mount system. In other words, a cable that is connected to the tablet can thus be routed first through the recess of the frame member and then through the cable passage of the wall mount in the assembled state of the wall mount system.

In another possible embodiment, the frame member comprises aluminum or is made of aluminum.

In another possible embodiment, the wall mount comprises steel or is made of steel.

In one example, the foam pad(s) is/are removably attached to the wall mount. Alternatively or additionally, the silicone pad(s) can be detachably attached to the frame member. The detachable attachment can be, for example, a plug-in or snap-in connection.

Further, it is possible that at least one foam pad is aligned with one of the holes when the wall mount system is assembled. In a preferred embodiment, each of the holes is covered by a respective foam pad.

Further preferably, the frame member according to the invention has a recess in the region of the first fastening means, which is designed and dimensioned in such a way as to accommodate the wall mount in the assembled state and to prevent the wall mount from slipping downwards, in particular if the first fastening means is designed as a magnet.

The invention is explained in more detail below by means of embodiment examples with reference to the drawings. In the Figures,

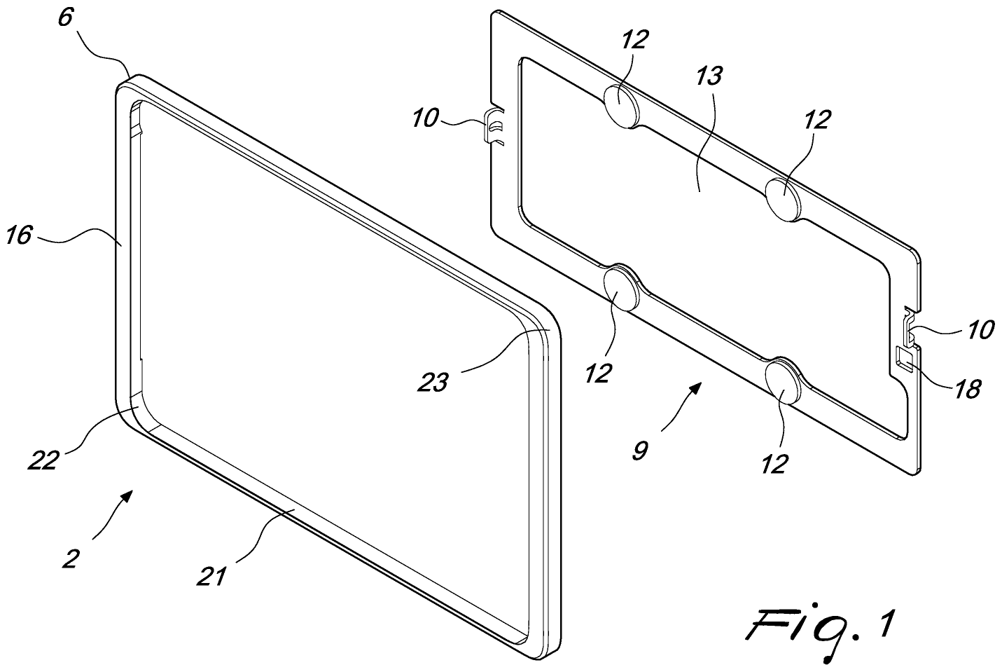

FIG. 1 shows an exploded perspective front view of the wall mount system according to the invention;

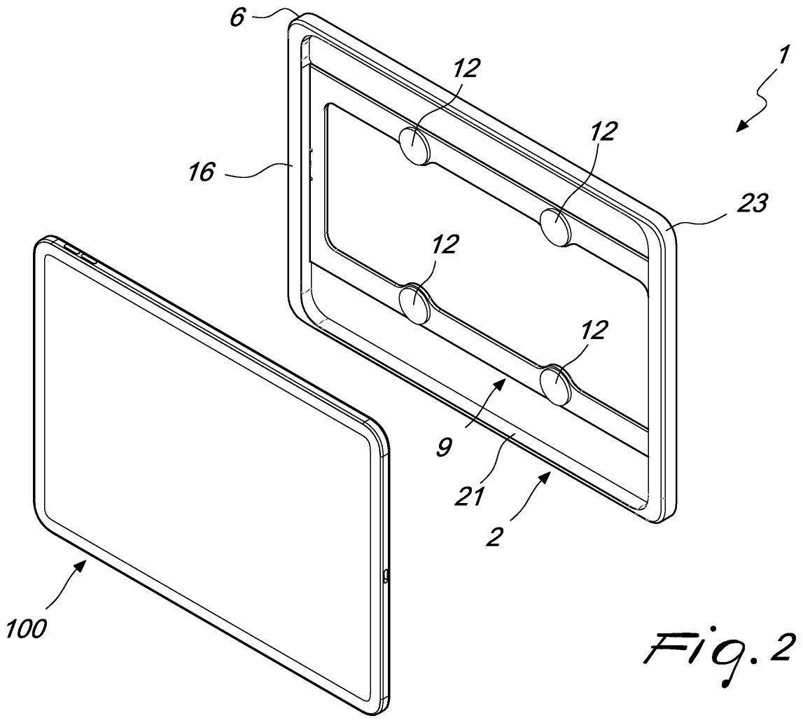

FIG. 2 shows a wall mount system according to the invention in a perspective front view and assembled, with no tablet installed;

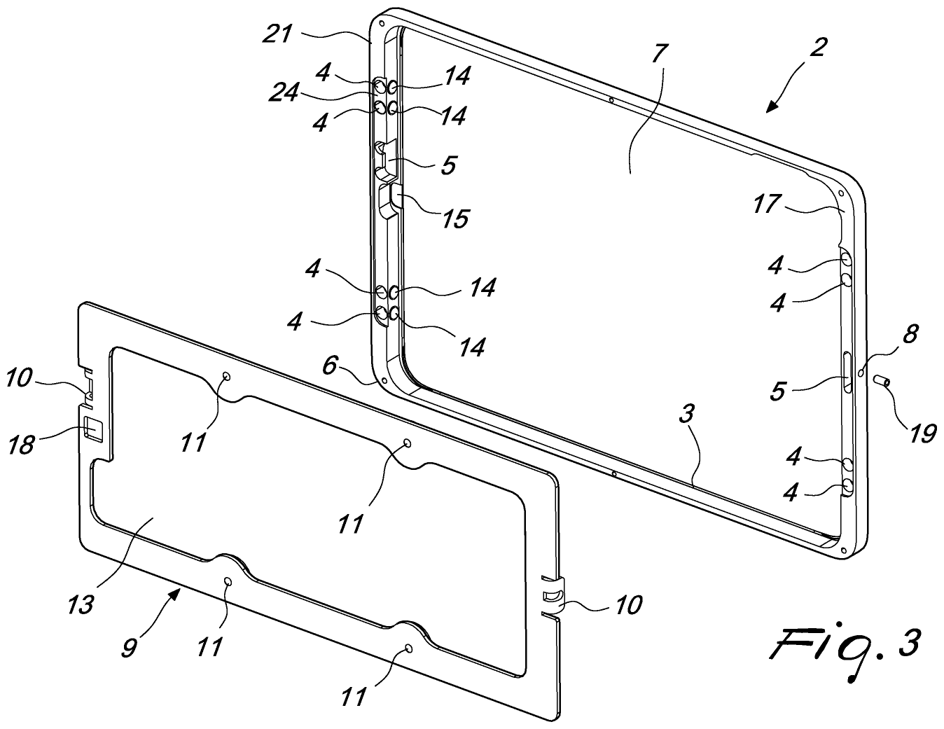

FIG. 3 shows an exploded perspective rear view of the wall mount system according to the invention;

FIG. 4 shows a wall mount system according to the invention in a perspective rear view and assembled, with a tablet installed;

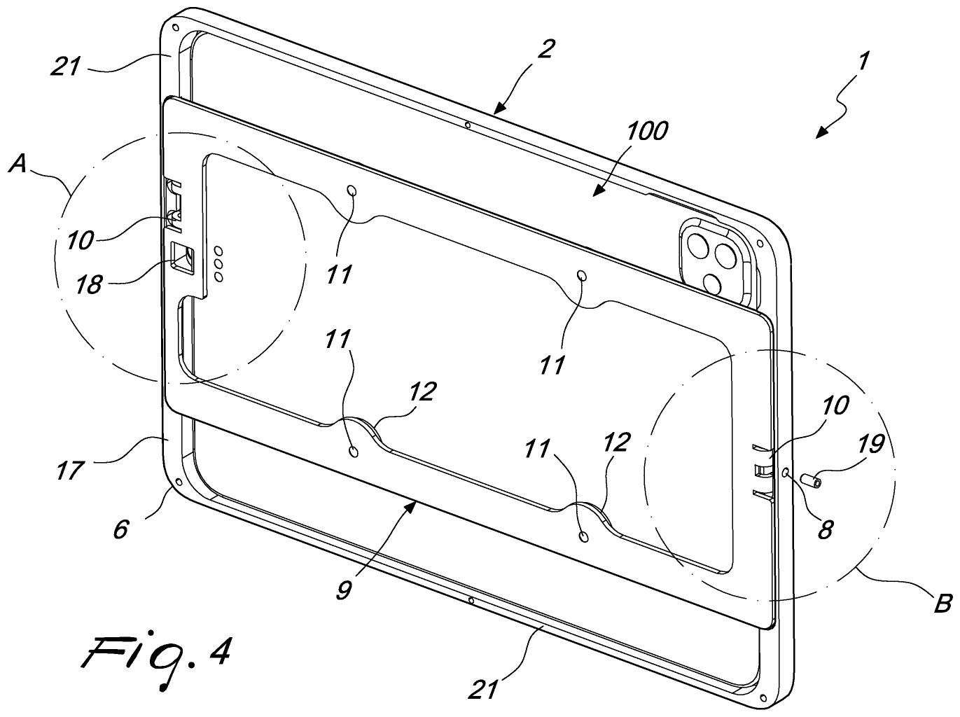

FIG. 5 shows an enlarged rear view of the wall mount system in the assembled state, in the left area A of FIG. 4;

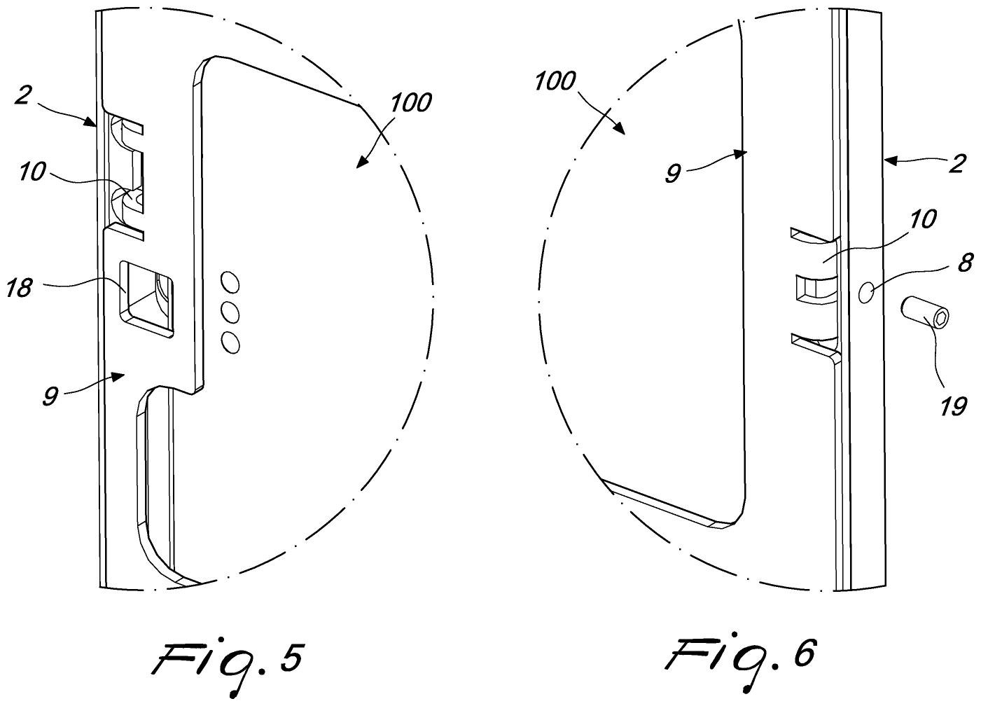

FIG. 6 shows an enlarged rear view of the wall mount system in the assembled state, in the right area B of FIG. 4;

FIG. 7 shows an enlarged view of the fastening means and counterpart fastening means of the wall mount system according to the invention;

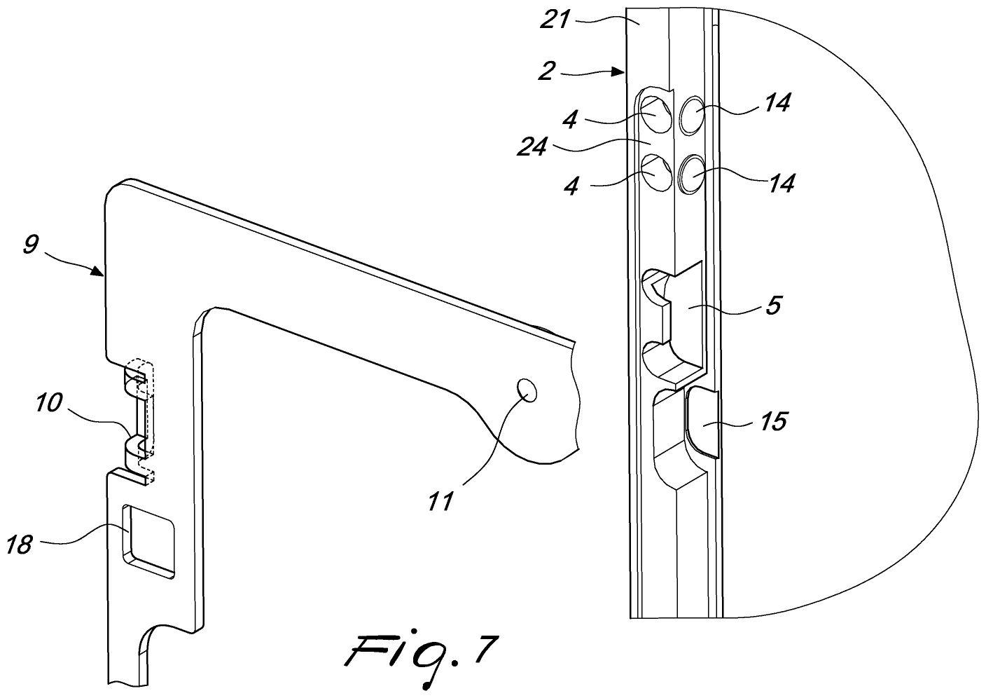

FIG. 8 shows a wall mount system according to the invention from the rear in an assembled state;

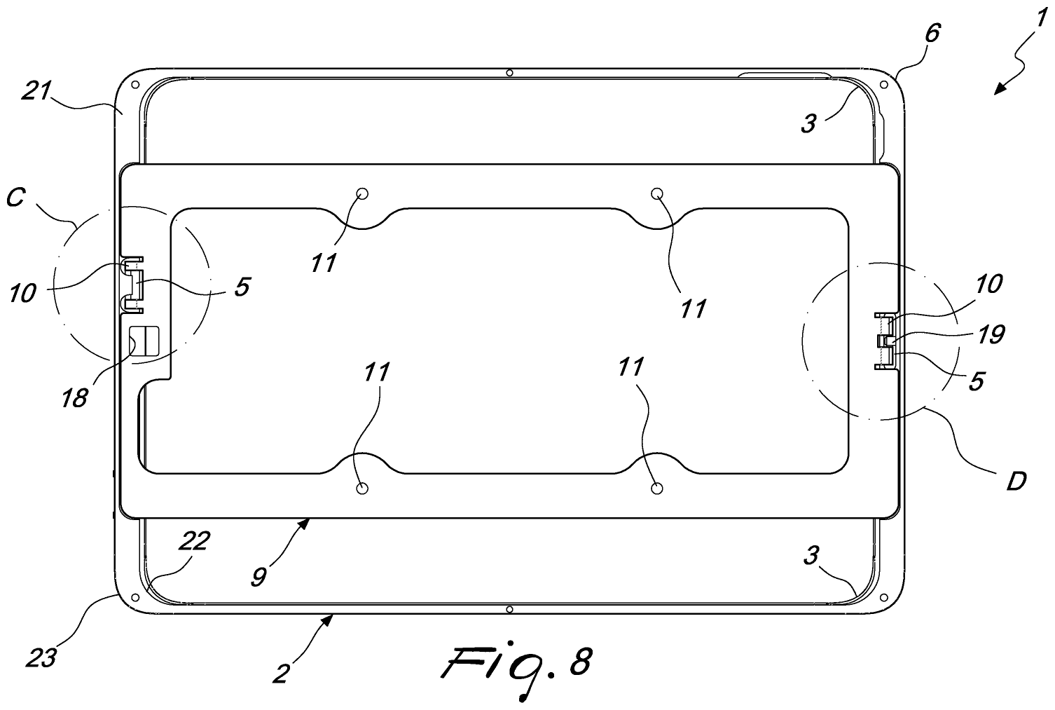

FIG. 9 shows an enlarged view of the second fastening means and second counterpart fastening means of the wall mount system according to the invention in the left area C of FIG. 8;

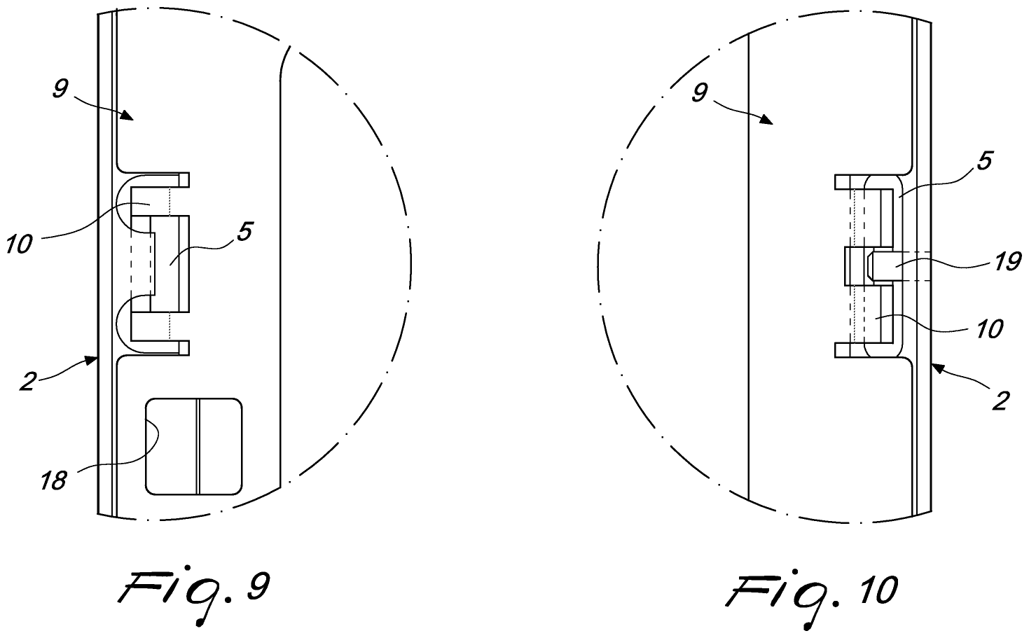

FIG. 10 shows an enlarged view of the second fastening means and second counterpart fastening means of the wall mount system according to the invention in the right area D of FIG. 8;

FIG. 11 shows a frame member according to the invention from the rear;

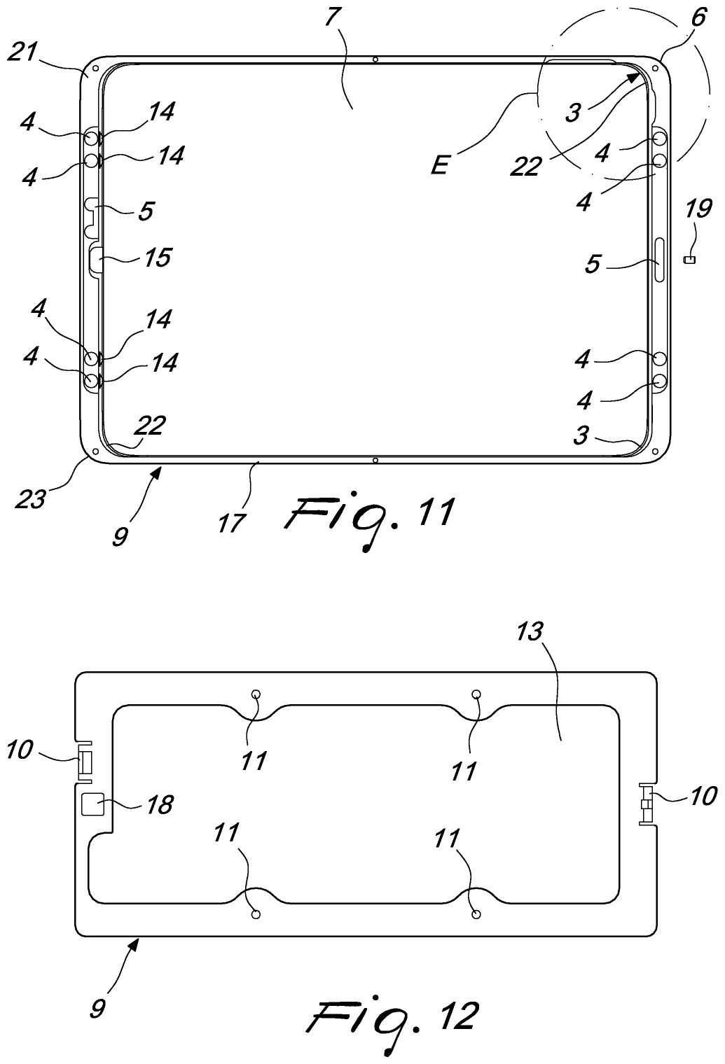

FIG. 12 shows a wall mount according to the invention from the front;

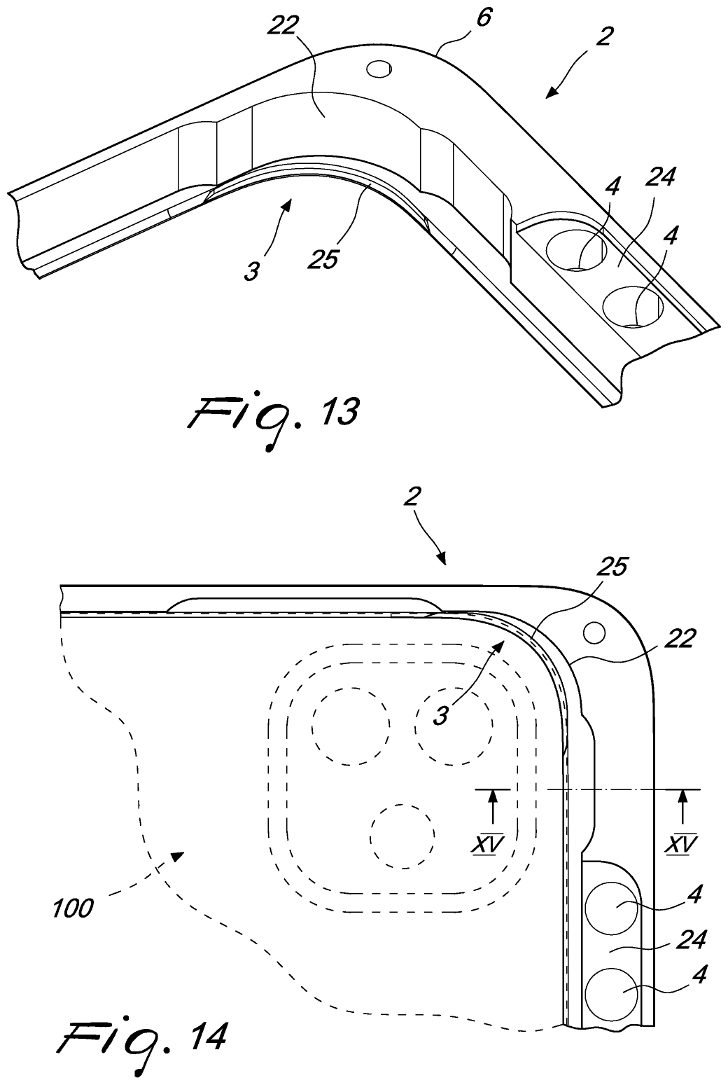

FIG. 13 shows an enlarged view of the area E of FIG. 11;

FIG. 14 shows an enlarged view of the area E of FIG. 11 with the tablet inserted;

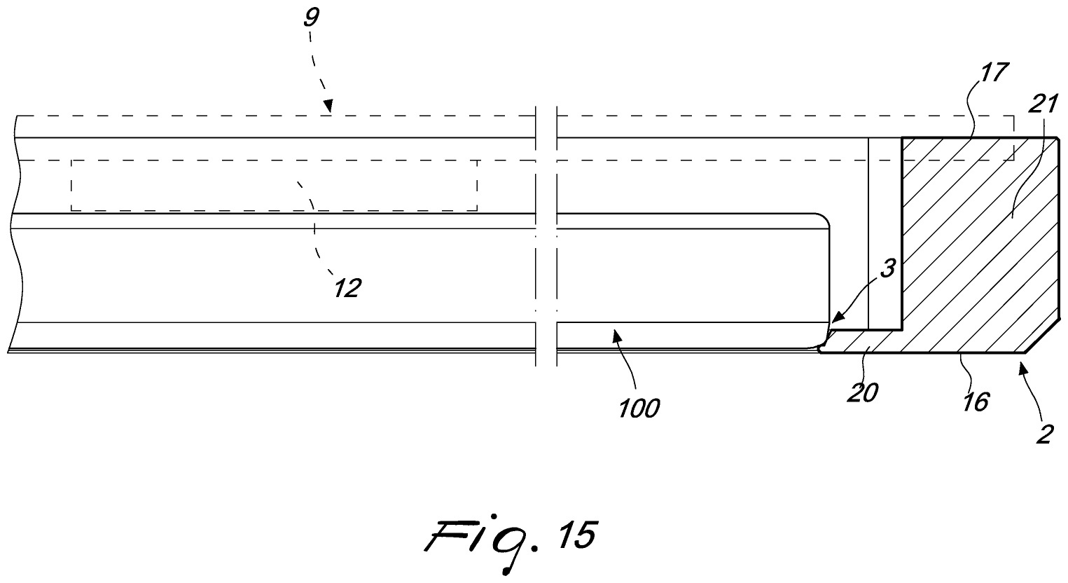

FIG. 15 shows a sectional view of a side wall of the frame member according to the invention along the sectional plane XV-XV of FIG. 14;

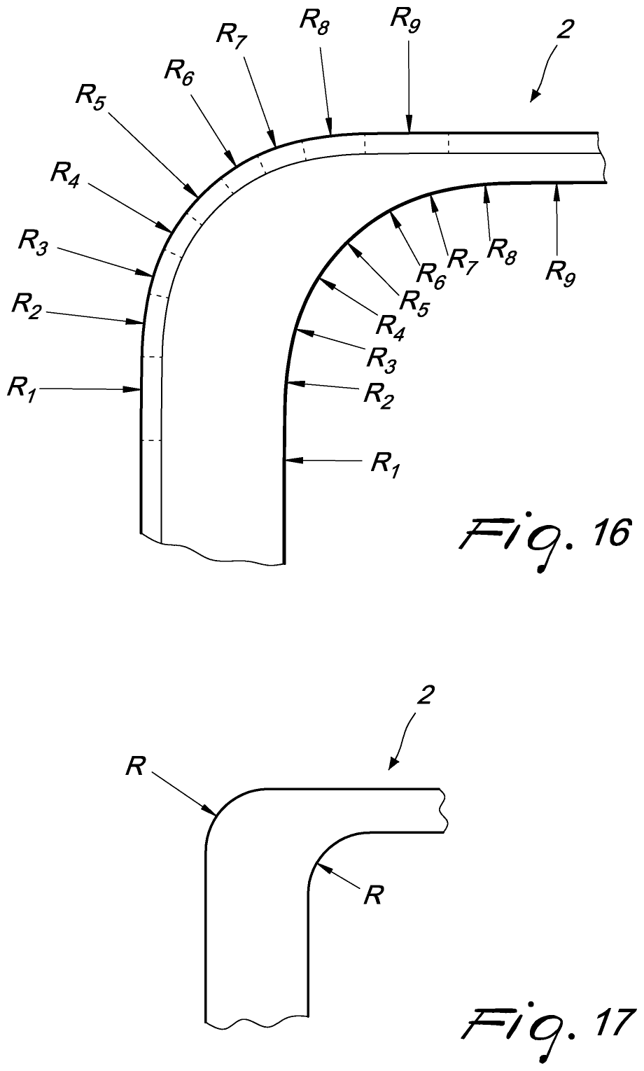

FIG. 16 shows an embodiment of the corner of one of the frame members according to the invention; and

FIG. 17 shows another alternative configuration of the corner of one of the frame members according to the invention.

Embodiments of the wall mount system 1 according to the invention are shown, for example, in the Figures of the invention.

With reference to FIG. 2 or 4, a wall mount system 1 according to the invention comprises a frame member 2 and a wall mount 9.

First, with reference to FIGS. 11 and 15, the frame member 2 according to the present invention will be described. The frame member 2 has a rear side 17, which faces a wall in the assembled state, and a front side 16, which is opposite the rear side 17. According to the present invention, the frame member 2 comprises a receptacle 3 for providing a mount for the tablet 100 in the receptacle 3. The receptacle 3 may be formed as a projecting edge 20 on the front side 16 of the frame member 2, as shown in FIG. 15.

The frame member 2 further comprises a first fastening means 4, wherein the first fastening means 4 is arranged at the rear side 17 of the frame member 2, as exemplified in FIG. 3 or 11. The first fastening means 4 may be configured as at least one magnet, where at least two, four or eight magnets are also possible, as shown by way of example. According to the invention, the magnet or magnets can preferably be attached to the frame member 2 by an adhesive connection.

Preferably, the frame member 2 has at least one recess 24 in the area of the first fastening means 4, which is designed to receive the wall mount 9 in the mounted state. The recess or recesses 24, as shown in particular in FIGS. 3 and 7, match(es) the width of the wall mount 9 exactly, so that the latter cannot slip downwards in the mounted state. The recesses 24 are particularly advantageous if the first fastening means 4 is designed as a magnet.

In addition, a second fastening means 5 is provided, the second fastening means 5 being arranged on the rear side 17 of the frame member 2, as also shown, for example, in FIG. 3 or 11. According to the invention, the second fastening means 5 are preferably recesses which are designed for connection to corresponding means described below, such as snap elements.

In addition, a screen cutout 7 for a screen of the tablet 100 is provided in the center of the frame member 2. The screen cutout 7 corresponds approximately to the size of the visible screen of a tablet.

In one embodiment, the frame member 2 comprises aluminum or is made of aluminum. Aluminum is preferred because of its low weight. In addition, aluminum can advantageously be coated, for example powder-coated, or anodized. According to the invention, the frame member 2 can thus advantageously be designed in various ways and is also less susceptible to soiling.

With reference in particular to FIGS. 3 and 12, the wall mount 9 of the wall mount system 1 according to the invention shall now be described. The wall mount 9 has a second counterpart fastener 10, the second counterpart fastener 10 being designed for connection to the second fastening means 5 of the frame member 2. The connected state of the second counterpart fastener 10 with the second fastening means 5 is illustrated in the area A of FIG. 4 and in the corresponding enlarged view of FIG. 5.

Furthermore, the wall mount 9 preferably comprises a further second counterpart fastener 10, wherein the further second counterpart fastener 10 is configured for connection to the corresponding second fastening means 5 of the frame member 2. The connected state of the second counterpart fastener 10 with the corresponding second fastening means 5 is illustrated in the area B of FIG. 4 and in the corresponding enlarged view of FIG. 6.

Advantageously, the second counterpart fastener 10 is provided by at least partially forming the wall mount 9 from a metal material.

Preferably, the connection of the second counterpart fastener 10 can be realized as a snap element, which is designed to cooperate with corresponding recesses of the frame member 2. The recesses thus form the second fastening means 5. However, according to the invention, a reverse design of the snap elements and recesses on the frame member 2 and the wall mount 9 is also possible.

Furthermore, holes 11 are provided in the wall mount 9, as shown in FIGS. 3, 4, 7, 8 and 12, for fastening the wall mount 9 on the wall. In particular, at least two or four holes 11 are provided.

In addition, the wall mount 9 has at least one foam pad 12 to hold and/or cushion the tablet 100. Preferably, there are at least two and in particular four foam pads 12. In a preferred embodiment, the number of foam pads 12 corresponds to the number of holes 11 and the foam pads 12 each cover one hole 11, as shown for example in FIG. 1 or 2. Preferably, the foam pads 12 may be attached by adhesive bonding, and the wall mount 9 may have enlarged portions corresponding to the foam pads 12, as also shown in FIGS. 1 and 2. Preferably, the enlarged portions and the foam pads 12 are circular.

Furthermore, as shown for example in FIG. 1, a central recess 13 is advantageously provided in the center of the wall mount 9 to enable the wall mount 9 to be arranged above a power supply unit or the like. The power supply unit, which is not shown, can be mounted flush in the wall in the area of the recess 13.

In one embodiment, the wall mount 9 comprises steel or is made of steel. Making the wall mount 9 of steel is advantageous, as a detachable connection with the first fastening means 4, in particular if the latter is designed magnetically, can be easily realized.

The assembled state is achieved in particular when the frame member 2 is connected to the wall mount 9. This is shown, for example, in FIG. 2 or 4.

According to the invention, a fastening means can be part of a two-part fastening means, i.e., for example, a recess 15 for a corresponding snap-in or latching element, or a snap-in or latching element for a corresponding recess 15. This can be seen, for example, in FIG. 7, in which the second fastening means 5 of the frame member 2 and the second counterpart fastener 10 of the wall mount 9 are shown.

The attachment of the wall mount 9 to the wall can be provided by screws which are guided through the holes 11 in the wall mount 9. According to the invention, a foam pad 12 may be made of various materials, for example cellular plastic, polystyrene or rubber. The foam pads 12 can be detachably attached to the wall mount 9, for example by a plug-in connection, or non-detachably, for example by an adhesive connection, as described above.

It may further be provided that the receptacle 3 is formed as a protruding edge 20 on the front side 16 of the frame member 2 with a side wall 21 extending toward the rear side 17 to lock an insertion of the tablet 100 into the receptacle 3 with the protruding edge 20. This is shown in the sectional view in FIG. 15.

Furthermore, the frame member 2 may further comprise at least one silicone pad 14 to provide improved retention of the tablet 100, where the at least one silicone pad 14 is preferably arranged in the side wall 21, such as shown in FIG. 3. In addition to improving retention of the tablet 100, the at least one silicone pad 14 also ensures that different types of tablets 100 with different sizes fit into the receptacle 3 of the frame member 2. Thus, advantageously, different thicknesses of the silicone pads 14 may be provided, which vary according to the tablet size and are accordingly fixed in the frame member 2. The silicone pads 14 may be made of other materials in addition to silicone, as long as the purpose of improved retention and adaptation to different tablet sizes is achieved. In one embodiment, which is shown in FIG. 3 or 11, four silicone pads 14 are present.

In a further embodiment, the first fastening means 4 is embodied as a magnet and a first counterpart fastener is formed of a metal material for releasably fastening the frame member 2 to the wall mount 9 with the magnet. Preferably, the metal material at least partially forms the wall mount 9, and further preferably the wall mount 9 is made of the metal material. In other words, the wall mount 9 may either be constructed in one piece from the metal material, or it may have a plurality of layers or portions which are made of the metal material, in which second case the position of the metal material in the assembled state corresponds to the position of the magnets.

It is conceivable that at least two, preferably four magnets are provided as the first fastening means 4 on the rear side 17 of the frame member 2. For optimized retention of the frame member 2 on the wall mount 9, the magnets may be arranged on respective opposite sides of the frame member 2, for example at or near each of the four corners 6 of the frame member 2 as shown in FIG. 3 or 11, for example. It is also conceivable that eight magnets are provided on the frame member 2, as shown in FIGS. 3 and 11 for example.

It may be advantageous if the second fastening means 5 is formed as a recess on the rear side 17 of the frame member 2, wherein the second counterpart fastening means 10 on the wall mount 9 is formed as a snap element for fastening the frame member 2 to the wall mount 9 in a preferably releasable manner. In other words, a corresponding snap system is formed here, in which the second fastening means 5 of the frame member 2 cooperates with the second counterpart fastener 10 of the wall mount 9, in that the second counterpart fastener 10 can be inserted as a snap element into the second fastening means 5 forming a recess. This can be seen in an enlarged view in FIGS. 9 and 10, which correspond to the areas C and D of FIG. 8. However, a reverse version is also conceivable, in which the second fastening means 5 is designed as a snap element and the second counterpart fastener 10 is designed as a recess.

In another example, at least two snap elements are provided as second counterpart fasteners 10. Alternatively or additionally, the snap element(s) may be formed in one piece with the wall mount 9. In the case of at least two snap elements, a counter-snap element can be formed on the respective opposite side, so as to improve the retention of the frame member 2 on the wall mount 9. This design can be seen, for example, in the exploded view of FIG. 3.

In addition, a third fastening means 8 can be provided, which is preferably formed as a hole in the frame member 2 with a matching safety screw 19, in order to detachably fasten the frame member 2 to the wall mount 9. The third fastening means 8 can counteract loosening and falling of the tablet 100. The third fastening means 8 in the form of a hole and a safety screw 19 can be seen particularly well in the enlarged view of FIG. 6. The third fastening means 8 is particularly suitable for securing the connection of the second fastening means 5 with the second counterpart fastener 10.

The frame member 2 may be substantially rectangular and have outer rounded corners 6, as shown in FIG. 11. The length to width ratio of the frame member 2 preferably corresponds to that of a conventional tablet 100, with a protrusion preferably being provided to allow the first and second fastening means 5 of the frame member 2 to be arranged therein. The protrusion may be provided by at least one side wall 21 or both side walls 21 on one short side or both short sides of the frame member 2.

In an advantageous embodiment, as shown in FIG. 17, the frame member 2 also has inner rounded corners 22, where the radii R of the inner and outer corners 22 and 6 are equal.

In another particularly advantageous embodiment, as shown in FIG. 16, the substantially rectangular frame member 2 has inner rounded corners 22 around its screen cutout 7 and/or outer rounded corners 6 around the screen cutout 7. In this further embodiment, it is particularly advantageous if at least one inner rounded corner 22 is composed of circular subregions having different radii and/or at least one outer rounded corner 6 is composed of circular subregions having different radii. Subregions with different radii are generally advantageous, particularly with regard to rounded corners that take the course of a spline curve, as is common in tablets. Such subregions with different radii are advantageous from a manufacturing point of view and are easier to realize. In addition, manufacturing tolerances are less strict and the subregions with different radii offer the tablets a good grip without damaging them in the inserted state. Also, an embodiment of all inner and/or outer corners 22, 6 with circular subregions with different radii is furthermore advantageous.

A particularly preferred design, as shown in FIG. 16, is when the subregions of the inner and/or outer corners 22 and 6 have radii R1 to R9 which are identical in pairs. Of course, the number of equal radii in pairs according to the invention is not limited to 9 and can be adapted by the person skilled in the art depending on the size of the corner 6, 22, for example.

The design of the inner rounded corners 22 and the outer rounded corners 6 can be such that at least one side wall 21 of the frame member 2 is thicker than the other side walls 21 of the frame member 2. Accordingly, the protrusion described above is formed on this at least one side wall 21. A larger protrusion advantageously creates more space for providing fasteners and/or magnets and/or a further recess 15 described below, as shown for example in FIG. 11.

According to another preferred general aspect of the invention, a recess 25 is formed in at least one inner corner 22 of the frame member 2. FIGS. 13 and 14 illustrate the recess 25, with FIG. 14 showing the tablet 100 in the inserted state. The recess may be provided at one inner corner 22, advantageously at two inner corners 22, even further advantageously at three inner corners 22, and most preferably at all inner corners 22. The recess or recesses 24 is/are particularly advantageous when the tablet is an iPad or the like. In general, recesses are advantageous because they prevent damage to corners of tablets and improve manufacturability of the frame member 2 or reduce manufacturing tolerances.

In an advantageous embodiment, the frame member 2 has a recess 15 in the side wall 21 for storing various types of plugs and/or adapters. Since the frame member 2 is designed for different types of tablets 100 such as iPads and various Android devices, it may be advantageous to provide different types of plugs or adapters in the recess 15, such as for a USB-C and/or a Lightning connector. This allows a quick change from one type of tablet, such as an iPad, to another type of tablet, such as an Android device. The recess 15 can be seen, for example, in the enlarged view in FIG. 7.

It is conceivable and advantageous that the wall mount 9 comprises a cable passage 18, which is preferably aligned with the recess 15 in the mounted state of the wall mount system 1. In other words, a cable connected to the tablet 100 can thus be guided first through the recess 15 of the frame member 2 and then through the cable passage 18 of the wall mount 9 in the assembled state of the wall mount system 1. The cable passage 18 can be seen, for example, in FIG. 3 or FIG. 9.

It is understood that when an element is referred to as being “mounted on,” “connected to,” “coupled to,” or “in contact with” another element, the element may then be directly on, connected to, or coupled to the other element, or there may further be intervening elements that are either merely interposed or connect or couple or keep the element in contact with the other element. On the other hand, when an element is described as being “directly on” another element, “directly connected” thereto, “directly coupled” or “directly in contact”, this is to be understood as meaning that there are no interposed elements.

Although the expressions “first,” “second,” etc., may be used herein to refer to various elements, components, areas, and/or portions, such elements, components, areas, and/or portions are not limited by such expressions. The expressions are used only to distinguish one element, component, area, or portion from another element, component, area, or portion. Therefore, a first element, component, area or portion discussed below may be referred to as a second element, second component, second area or portion without departing from the teachings of the present invention.

Embodiments of the invention are described herein with reference to views that are schematic representations of embodiments of the invention. Therefore, the actual thickness of the components may differ therefrom, and variations from the shapes in the drawings, for example due to manufacturing processes and/or tolerances, are to be expected. Embodiments of the invention are not to be understood as limited to the particular shapes of the areas shown herein, but are intended to include variations in the shapes resulting, for example, from the method of manufacture. An area shown or designated as square or rectangular will typically also have rounded or curved features due to normal manufacturing tolerances. Therefore, the areas shown in the figures are schematic in nature, and their shapes are not intended to represent the exact shape of any area of a device or to limit the scope of protection of the invention.

Regarding the term “comprise,” it must be said for clarity purposes that, when a first device portion comprises a second device portion, this means that the first device portion “has” the second device portion and does not necessarily surround the latter in terms of arrangement unless, for example, an arrangement in terms of position and shape is described.

Further possible embodiments are described in the following claims. In particular, the various features of the embodiments described above can also be combined, provided they are not mutually technically exclusive.

The reference numbers mentioned in the claims are for convenience only and in no way limit the claims to the embodiments shown in the figures.

The embodiments shown here are only examples of the present invention and must therefore not be understood as limiting. Alternative embodiments contemplated by the person skilled in the art are equally encompassed by the scope of protection of the present invention.

### LIST OF REFERENCE SIGNS

1 wall mount system
2 frame member
3 receptacle
4 first fastening means
5 second fastening means
6 outer corners
7 screen cutout
8 third fastening means
9 wall mount
10 second counterpart fastener
11 holes
12 foam pads
13 central recess
14 silicone pads
15 recess
16 front side
17 rear side
18 cable passage
19 safety screw
20 protruding edge
21 sidewall
22 inner rounded corner
24 recess
25 recess
100 tablet

1. A wall mount system (1) for a tablet (100), the wall mount system (1) comprising:
a frame member (2), the frame member (2) having the following features:
a receptacle (3) to provide a retention for the tablet (100) in the receptacle (3),
a rear side (17) which faces a wall in the assembled state,
a front side (16), which is opposite the rear side (17),
a first fastening means (4), the first fastening means (4) being arranged at the rear side (17) of the frame member (2),
a screen cutout (7) for a screen of the tablet (100); and
a wall mount (9), the wall mount (9) having the following features:
a first counterpart fastener, the first counterpart fastener being configured for connection to the first fastening means (4) of the frame member (2),
holes (11) for fixing the wall mount (9) of the wall,
at least one foam pad (12) for retaining the tablet (100), and
a central recess (13) to allow the wall mount (9) to be positioned above a power supply unit.

2. The wall mount system (1) according to claim 1, wherein frame member (2) further comprises a second fastening means (5), said second fastening means (5) being arranged at the rear side (17) of said frame member (2), and wherein said wall mount (9) further comprises a second counterpart fastener (10), said second counterpart fastener (10) being adapted for connection to said second fastening means (5) of said frame member (2).

3. The wall mount system (1) according to claim 1, wherein the receptacle (3) is formed as a protruding edge (20) at the front side (16) of the frame member (2) with a sidewall (21) extending towards the rear side (17) to lock an insertion of the tablet (100) into the receptacle (3) with the protruding edge (20).

4. The wall mount system (1) according to claim 1, wherein the frame member (2) further comprises at least one silicone pad (14) to provide improved retention of the tablet (100), wherein the at least one silicone pad (14) is preferably arranged in the sidewall (21).

5. The wall mount system (1) according to claim 1, wherein the first fastening means (4) is formed as a magnet and the first counterpart fastener is formed of a metal material for releasably fastening the frame member (2) with the magnet to the wall mount (9), the metal material preferably at least partially forming the wall mount (9), and further preferably the wall mount (9) being made of the metal material.

6. The wall mount system (1) according to claim 5, wherein at least two, preferably four and further preferably eight magnets are provided as first fastening means (4) on the rear side (17) of the frame member (2).

7. The wall mount system (1) according to claim 2, wherein the second fastening means (5) is formed as a recess on the rear side (17) of the frame member (2) and wherein the second counterpart fastener (10) on the wall mount (9) is formed as a snap element for fastening the frame member (2) to the wall mount (9), preferably in a detachable manner.

8. The wall mount system (1) according to claim 7, wherein at least two snap elements are provided as counterpart fasteners (10) and/or wherein the snap element(s) is/are formed in one piece with the wall mount (9).

9. The wall mount system (1) according to claim 1, wherein a third fastening means (8) is provided, which is preferably formed as a hole in the frame member (2) with a matching safety screw (19) for detachably fastening the frame member (2) to the wall mount (9).

10. The wall mount system (1) according to claim 1, wherein the frame member (2) is substantially rectangular and has inner rounded corners (22) around the screen cutout (7), wherein at least one inner rounded corner (22) is composed of circular partial areas with different radii.

11. The wall mount system (1) according to claim 1, wherein the frame member (2) is substantially rectangular and has outer rounded corners (6), wherein at least one outer rounded corner (6) is composed of circular partial areas with different radii.

12. The wall mount system (1) according to claim 10, wherein a recess (25) is formed in at least one inner corner (22) of the frame member (2) such that a gap is formed at the inner corner (22) when the tablet (100) is mounted.

13. The wall mount system (1) according to claim 1, wherein at least one sidewall (21) of the frame member (2) is thicker than the other sidewalls of the frame member (2).

14. The wall mount system (1) according to claim 3, wherein the frame member (2) comprises a recess (15) in the sidewall (21) for storage of different connector types and/or adapter types.

15. The wall mount system (1) according to claim 1, wherein the wall mount (9) comprises a cable passage (18) which is preferably aligned with the recess (15) in the mounted state of the wall mount system (1).

16. The wall mount system (1) according to claim 1, wherein the frame member (2) comprises aluminum or is made of aluminum.

17. The wall mount system (1) according to claim 1, wherein the wall mount (9) comprises steel or is made of steel.

18. The wall mount system (1) according to claim 1, wherein the foam pad(s) (12) is/are detachably attached to the wall mount (9).

19. The wall mount system (1) according to claim 4, wherein the silicone pad(s) (14) is/are detachably attached to the frame member (2).

20. The wall mount system (1) according to claim 1, wherein at least one foam pad (1) is aligned with one of the holes (11) in the assembled state of the wall mount system (1).

21. The wall mount system (1) according to claim 1, wherein a frame member (2) has a recess (24) in the area of the first fastening means (4), which is formed in such a way as to receive the wall mount (9) in the assembled state.
